(19) United States
(12) Patent Application Publication
(10) Pub. No.: US 2015/0153456 A1
(43) Pub. Date: Jun. 4, 2015

(54) INTEGRATED MACHINE GUIDANCE SYSTEM

(71) Applicant: Hemisphere GNSS Inc., Scottsdale, AZ (US)

(72) Inventors: Walter Feller, Scottsdale, AZ (US); Randy B. Noland, Flemingsburg, KY (US)

(73) Assignee: Hemisphere GNSS Inc., Scottsdale, AZ (US)

(21) Appl. No.: 14/257,690

(22) Filed: Apr. 21, 2014

Related U.S. Application Data
(60) Provisional application No. 61/910,656, filed on Dec. 2, 2013.

(51) Int. Cl. G01S 19/13

(52) U.S. Cl. CPC G01S 19/13

(57) ABSTRACT

An integrated machine guidance system for guiding a critical device of a machine includes global navigation satellite system (GNSS) antennas, a GNSS receiver, a guidance controller, and a wireless communication system enclosed in a housing. The guidance controller is adapted to compute an actual position of the critical device and determine a direction that the critical device should move to arrive at a desired position. The housing may be coupled to a mounting element, which is attached to the critical device. A display unit is in communication with the guidance controller, and is coupled to the housing so that it is visible to an operator in the cab of the machine. The guidance controller may communicate with another display unit located remote from the housing via the wireless communication system. Each of the display units can provide an indication of the direction that the critical device should move.

### TECHNICAL FIELD OF THE INVENTION

The present invention relates generally to machine control using a global navigation satellite system (GNSS). More specifically, the present invention relates to an integrated machine guidance system using GNSS.

### BACKGROUND OF THE INVENTION

Earth-moving projects encompass a wide variety of excavating, grading, trenching, boring, scraping, spreading and other tasks, which are performed in connection with road-building, infrastructure improvements, construction, mining, agriculture, and other activities. Such tasks are typically performed by specialized earth-moving equipment, such as excavators, backhoes, bulldozers, loaders, motor graders, agricultural equipment, and so forth. Mobile earth-moving equipment is steered and otherwise guided within jobsites. Additionally, the working implements of such equipment, such as blades, drills, buckets and ground-engaging tools, are controlled through their various ranges of motion. The guidance and control of such earth-moving equipment was conventionally accomplished by human operators, who typically needed relatively high levels of skill, training, and experience for achieving maximum productivity with the equipment.

Attention is increasingly being directed toward the development of machine guidance and control systems to assist human operators. The term “machine guidance” is used to describe a wide range of techniques which improve the productivity of earth-moving, agricultural, mining, and construction equipment. Machine guidance systems often incorporate a global navigation satellite system (GNSS), e.g., Global Positioning System (GPS) or other satellite positioning system (SATPS) for accurate location determination. In addition, such a machine guidance system typically incorporates various sensors to determine equipment position and a cab-based display to provide feedback to the operator of relevant information which allows for improved control of the machine in relation to the intended or designed direction of travel.

GNSS-based machine guidance systems can provide a relatively high level of movement accuracy. For example, slope and grade measurements can be obtained with greater accuracy and quality control, thereby reducing or eliminating the need for manually performed grade checks. Additionally, GNSS-based machine guidance and control systems can provide more information and control to the equipment operators, thus enabling them to undertake more difficult tasks than they might otherwise have with manually-controlled equipment and techniques. Furthermore, consistency among operator performance can be improved via GNSS-based machine guidance, resulting in better overall job quality. And still further, machine operators benefit from less fatigue, as opposed to the manually-intensive control procedures requiring high degrees of concentration and operator interaction.

GNSS-based machine guidance and control systems typically require two GNSS antennas, radio frequency cables for the GNSS antennas, a dual GNSS receiver, an ultra high frequency (UHF) antenna, wireless receiver, and radio frequency cable for GNSS corrections, sensors, and a specialized cab-based central computer. Unfortunately, the communications cables to the sensors are difficult to install and maintain, and are costly to purchase. Furthermore, the antennas, sensors, and receivers must all connect via cabling to the cab-based central computer and must rely on this specialized central computer for processing and display functions.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, the Figures are not necessarily drawn to scale, and:

FIG. 1 shows an illustrative diagram of a vehicle including an integrated machine guidance system in accordance with an exemplary embodiment;

FIG. 2 shows an illustrative diagram of the integrated machine guidance system;

FIG. 3 shows a simplified block diagram of the integrated machine guidance system;

FIG. 4 shows a more detailed block diagram of the integrated machine guidance system; and

FIG. 5 shows an exemplary shock mount system for components within the integrated machine guidance system.

### DETAILED DESCRIPTION

Embodiments entail a machine guidance system for guiding a critical device of a machine. The machine may be earth-moving equipment, such as an excavator, backhoe, bulldozer, loader, motor grader, agricultural equipment, seeder, chemical sprayer, fertilizer spreader, and the like that is steered and otherwise guided within a jobsite. The critical device can entail the working implement of such earth-moving equipment, such as a blade, drill, bucket, agricultural implement, or any other ground-engaging tool for which guidance is provided via the machine guidance and control system. Multiple components are built into the machine guidance system to form a standalone unit, i.e., an integrated machine guidance system. Such an integrated approach achieves improvements in portability between multiple machines, ease of installation, and cost savings. Furthermore, there is no necessity for specialized equipment inside the cab of the machine, thereby greatly reducing or eliminating the need for multiple cables penetrating the cab of the machine and the costs associated therewith. Additionally, the absence of specialized equipment inside the cab of the machine reduces clutter in the small and crowded cab of the machine, and allows the operator to focus out at a distance reducing eyestrain and keeping the operator's attention where the work is taking place.

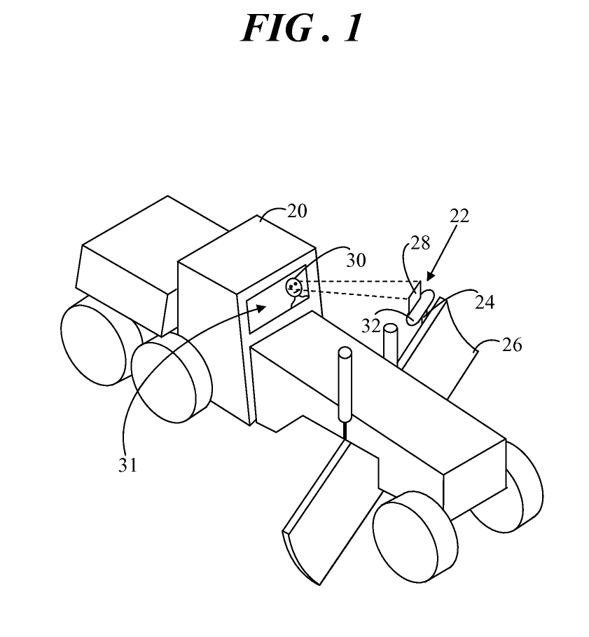

FIG. 1 shows an illustrative diagram of a machine 20 including an integrated machine guidance system 22 in accordance with an exemplary embodiment. Machine 20 may be earth-moving equipment, such an excavator, backhoe, bulldozer, loader, motor grader, agricultural equipment, seeder, chemical sprayer, fertilizer spreader, and the like. In an exemplary embodiment, machine guidance system 22 is fixed via an anti-vibration shock mount or a rigid mount 24 to a critical device 26 of machine 20. Critical device 26 may be an arm, blade, drill, bucket, agricultural implement, or any other ground-engaging implement for which guidance is provided via machine guidance system 22. Mount 24 is configured such that it fits securely with a predetermined orientation relative to critical device 26 and to facilitate an unimpeded view to the GNSS satellites (not shown). An accurate installation ensures that substantially no misalignment error is present that may otherwise cause a sensor system (not shown) installed in machine guidance system 22 to provide erroneous heading information.

System 22 can include all of the components needed to compute the actual position and attitude of machine 20 and/or critical device 26, and to determine a direction that machine 20 and/or critical device 26 should move to arrive at desired positions that are needed to create, for example, certain terrain features. The directions for machine movement can be displayed on a display unit 28 that is visible to an operator 30 positioned at another location remote from integrated machine guidance system 22. For example, operator 30 may be positioned in an operator station, such as a cab 31 of machine 20. Display unit 28 may be coupled to an external surface of a housing 32 of integrated machine guidance system 22 in a line of site of operator 30. By having display unit 28 located outside of cab 31, clutter may be reduced in the small and typically crowded cab 31. Moreover, the location of display unit 28 allows operator 30 to focus out at a distance, thereby reducing eyestrain and enabling the operator's attention to be where the work is taking place.

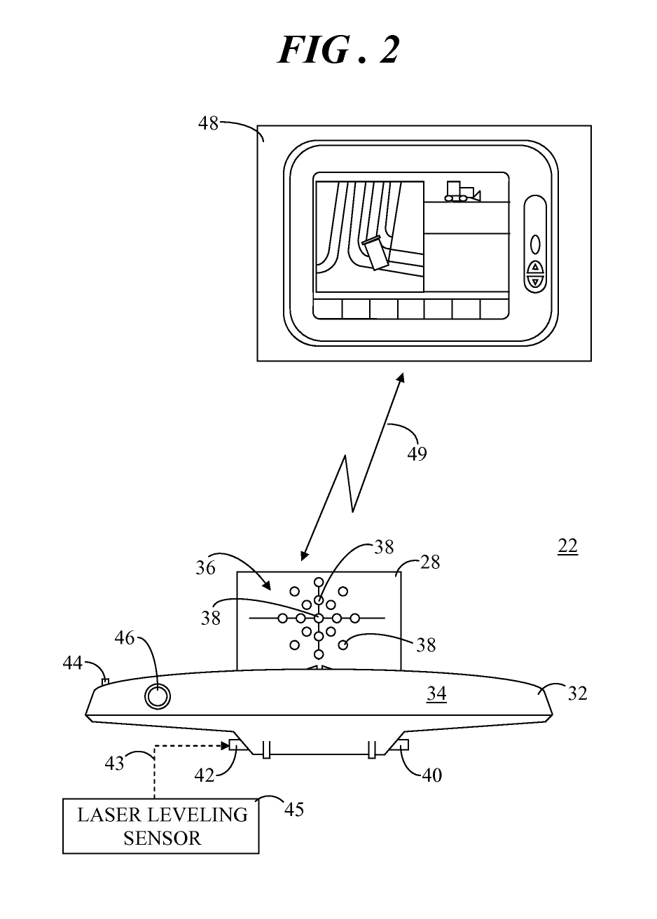

FIG. 2 shows an illustrative diagram of integrated machine guidance system 22. System 22 includes housing 32 in which the components are enclosed. Housing 32 may be a durable weatherproof enclosure suitable for effectively protecting the sensitive internal components. Display unit 28 is coupled to an external surface 34 of housing 32. Coupling of display unit 28 to external surface 34 of housing 32 may be accomplished using a variety of fasteners and fastening techniques.

In the illustrated embodiment, display unit 28 is a simple rugged display that includes an arrangement of indicators 36 adapted to indicate the direction that critical device 26 (FIG. 1) should move. The arrangement of indicators 36 may include a plurality of lamps 38 (e.g., Light Emitting Diodes) arranged in a grid pattern. Activation of certain lamps 38 and a certain color scheme may provide the indication of the direction that critical device 26 is to move or a shift away from the direction that critical device 26 should move. For example, the objective may be to guide machine 20 such that the centermost lamp 38 is lit green when critical device 26 is being moved, or has moved, in the appropriate direction. At least some of the next set of lamps 38 radiating outwardly from the centermost lamp 38 could illuminate yellow should critical device 26 move slightly away from the appropriate direction, and at least some of the outermost set of lamps 38 could illuminate red should critical device 26 move significantly away from the appropriate direction. Thus, certain lamps 38 could illuminate to signify upward/downward shift, rightward/leftward shift, and even tilt.

Those skilled in the art will recognize that display unit 24, visible by operator 30 within cab 31 of machine 20, can be configured differently and may be configured to include warning and condition alerting. For example, display unit 24 may include light bars, arrows, or other indications for operator 30 to see.

Certain ports may extend through housing 32. In an exemplary embodiment, an input/output (I/O) port 40 extends through housing 32. I/O port 40 may be utilized to provide a power connection via a single cable to machine guidance system 22. In some configurations, I/O port 40 may carry optional data pins for data connection in order to interface the controller area network (CAN) bus for machine 20. This optional data connection could be used for remote display, setup, and control. Additionally, a laser level input port 42 can extend through housing 32 to provide a laser level signal 43 from a laser leveling sensor 45 to components within housing 32. Additional ports may include an external radio antenna port and/or a GNSS antenna port 44. Antenna ports 44 are represented by a single port in housing 32 for simplicity of illustration. However, it should be understood that housing 32 may include more than one antenna port 44 in accordance with a particular design configuration.

In some embodiments, integrated machine guidance system 22 may further include at least one camera 46. In this illustration, the lens of camera 46 extends through housing 32. Camera(s) 46 can be utilized to permit operator 30 to view images of the environment proximate camera(s) 46 from within cab 31 of machine 30.

In some embodiments, machine guidance system 22 may include another display unit 48 that is physically separate and detached from housing 32. Display unit 48 may be a tablet, pad, smart phone, or other computing system residing in cab 31 of machine 20. Alternatively or additionally, remote display unit 48 may be at a location that is not part of machine 20, such as in a construction office. Display unit 48 may be in communication with the components within housing 32 via a wireless communication link 49 in order to provide higher update rate and resolution displays for user interface, control, and guidance. For example, display unit 48 may be implemented to provide more detailed information to the machine operator 30 (FIG. 1) and/or a supervisor regarding terrain features. Additionally or alternatively, display unit 48 may be utilized to provide means for operator 30 or the supervisor to upload files and control software to the components within housing 32 over wireless communication link 49, as will be discussed in greater detail below. Furthermore, images provided by camera(s) 46 may be communicated to display unit 48 over wireless communication link 49 for presentation on the higher resolution display unit 48.

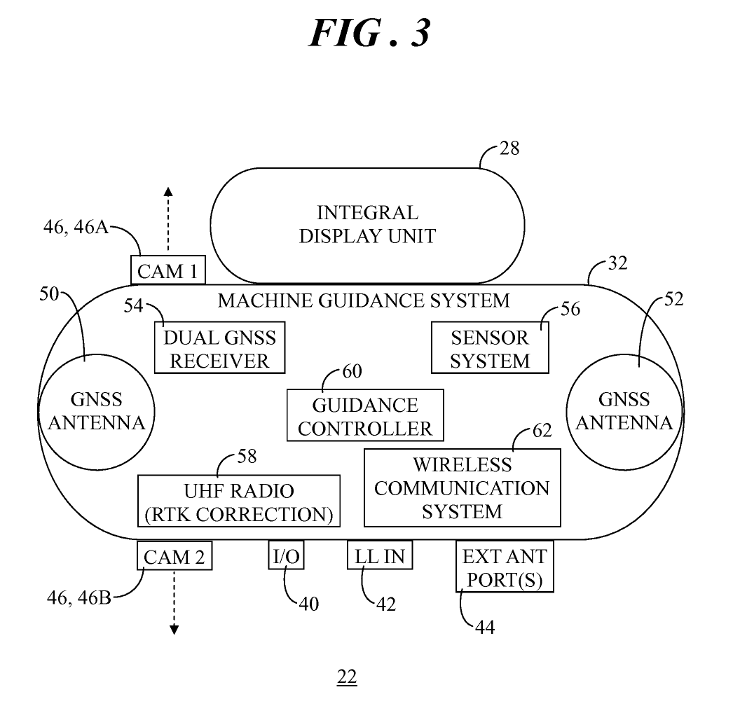

FIG. 3 shows a simplified block diagram of components within housing 32 of integrated machine guidance system 22. Machine guidance system 22 generally includes two GNSS antennas 50, 52, a dual channel GNSS receiver 54, a sensor system 56, and an ultra high frequency (UHF) radio system 58 enclosed within housing 32. GNSS antennas 50, 52 along with dual GNSS receiver 54 co-operate as a primary receiver system and a secondary receiver system. Sensor system 56 includes, but is not limited to, accelerometers, gyroscopic sensors, compasses, magnetic sensors, inclinometers, and the like, as well as combinations including at least one of the aforementioned sensors. UHF antenna/radio system 58 receives real time kinematic (RTK) corrections in accordance with known methodology.

As further shown in FIG. 3, integrated machine guidance system 22 includes two cameras 46, i.e., a camera 46A and another camera 46B arranged in opposing directions to provide views of an environment in which integrated machine guidance system 22 is located. I/O port 40, laser level input port 42, and exterior antenna ports 44 are additionally generally presented in FIG. 3.

In accordance with a particular embodiment, machine guidance system 22 further includes a guidance controller 60 and a local area network (LAN) wireless communication system 62 enclosed within housing 32. GNSS antennas 50, 52, dual channel GNSS receiver 54, sensor system 56, UHF antenna/radio system 58, cameras 46, ports 40, 42, 44, guidance controller 60, wireless communication system 62, and display unit 28 are all provided on or within the durable weather resistant housing 32 so that it may be readily mounted to and utilized with machinery that does not possess its own specialized computing system, and for enhanced portability between multiple machines, ease of installation, and cost savings.

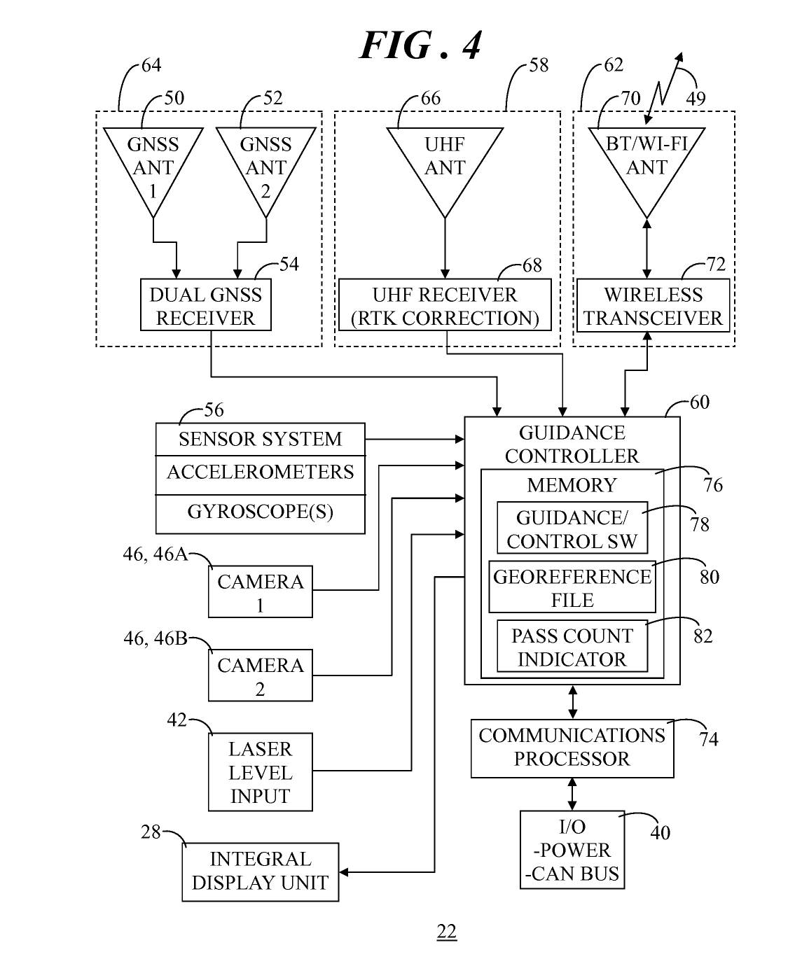

Referring now to FIGS. 3 and 4, FIG. 4 shows a more detailed block diagram of integrated machine guidance system 22. GNSS antennas 50, 52 and dual channel GNSS receiver 54 form a GNSS receiver/antenna system 64. A UHF antenna 66 and a UHF receiver 68 form UHF radio system 58, and a local area network (LAN) antenna 70 and LAN wireless transceiver 72 implementing, for example, a Bluetooth or Wi-Fi communication standard, form wireless communication system 62. In general, Bluetooth is a wireless technology standard (IEEE 802.15.1) for exchanging data over between devices that are near one another. Wi-Fi is the brand name for products using IEEE 802.11 standards and has similar applications to Bluetooth.

GNSS receiver/antenna system 64, UHF radio system 58, and wireless communication system 62 are connected to and in communication with guidance controller 60. Similarly, sensor system 56, cameras 46, and laser level input 42 are connected to and in communication with guidance controller 60. Additionally, a communications processor 74 may be connected to and in communication with guidance controller 60, wherein communications processor 74 is additionally connected to I/O port 40.

Guidance controller 60 includes a memory element 76 associated therewith. In some embodiments, guidance and control software 78, at least one georeference file 80, and a pass count indicator 82 may be stored in memory element 76 for use by guidance controller 60. Other files that may be stored in memory element 76 could include configuration files, auto-steering controls, and/or other semi-autonomous and autonomous controls.

In accordance with an embodiment, georeference file 80, a desired build file, or other terrain data files containing, for example, the terrain mapping goal for machine 20 (i.e., the final terrain features) may be uploaded over wireless communication link 49 via wireless communications system 62 (e.g., Bluetooth or Wi-Fi) to memory element 76 associated with guidance controller 60. Similarly, guidance and control software 78, pass count indicator 82, and other files and configurations, auto-steering controls, and/or other semi-autonomous and autonomous controls in accordance with a particular machine function may be uploaded over wireless communication link 49. Additionally, guidance controller 60 accepts input data from GNSS antenna/receiver system 64, sensor system 56, UHF radio system 58, and laser level input 42.

GNSS antennas 50, 52 of GNSS antenna/receiver system 64 are mounted within housing 32 at a substantially fixed relative position with respect to one another, and dual channel GNSS receiver 54 is configured to facilitate communication between the dual channels of receiver 54 and resolve the attitude information from the phase center of GNSS antenna 50 to the phase center of GNSS antenna 52 with a high degree of accuracy. Input data from GNSS antenna/receiver system 64 enclosed in housing 32 can provide information pertaining to the actual position and heading of machine 20 and, more specifically, of critical device 26 since GNSS antenna/receiver system 64 within housing 32 is mounted to critical device 26. Sensor system 56, enclosed in housing 32 and mounted on critical device 26 (FIG. 1), can provide additional and more detailed information of the position, heading, tilt, yaw, pitch, and roll of critical device 26.

UHF radio system 58 provides real time kinematic (RTK) corrections to enhance the precision of position data derived from GNSS antenna/receiver system 64 in accordance with a known real-time kinematic position-determining mode. The RTK corrections may provide up to centimeter level accuracy.

Laser level input 42 can provide laser level signal 43 from laser leveling sensor 45 (FIG. 2). As known to those skilled in the art, a laser level is a control tool that includes a laser beam projector affixed to a tripod. A laser beam from the projector is leveled and then spun to illuminate a horizontal plane. Laser leveling sensor 45, which can detect the laser beam, is suitably located and can detect the laser beam. Laser leveling sensor 45 provides laser level signal 43 when sensor 45 is in line with the beam. The position of laser leveling sensor 45 relative to a measuring device allows comparison of elevations between different points on the terrain. Thus, laser leveling sensor 45 can provide another input of what the actual earth grade is as compared to what it should be. Additionally, the movement of critical device 26 may be guided in response to laser level signal 43 from laser leveling sensor 45.

Guidance controller 60 executes guidance control software 78 to compute the actual position and attitude of machine 20 and/or critical device 26 and to determine the direction that machine 20 and/or critical device 26 should move to arrive at a desired position in order to create the desired terrain map provided in georeference file 80. The movement information may be provided to operator 30 (FIG. 1) of machine 20 using integral display unit 28. Additionally or alternatively, the movement information may be provided to operator 30 of machine 20 by communicating the information over wireless communication link 49 from wireless communications system 62 to remote display unit 48 (FIG. 2).

Cameras 46A, 46B which interface with guidance controller 60 can provide different views and angles for operator 30 to see. Images from cameras 46A, 46B can be communicated over wireless communication link 49 for presentation on remote display 48. For example, backup cameras 46 can be turned on and the view can be presented on remote display 48 when it is sensed that machine 20 is in reverse.

Pass count indicator 82 associated with guidance controller 60 may be formed from software, firmware, hardware, or some combination thereof. Pass count indicator 82 enables guidance controller 60 to count or otherwise keep track of how many “passes” or “excursions” are made over a predetermined terrain area. The information from pass count indicator 82 can be used to keep track of the passes in order to monitor the compaction of soil, asphalt, concrete, solid waste, and so forth. The number of passes can be determined from the information received by guidance controller 60 from GNSS receiver/antenna system 64 and sensor system 56.

Some embodiments may further include communications processor 74 in communication with guidance controller 60 and I/O port 40. Generally, I/O port 40 can be utilized to provide power to the components within housing 32 via a power cable (not shown). However, communications processor 74 may be included in housing 32 and may be connected with I/O port 40 to enable a single cable interface to a controller area network (CAN) bus of machine 20 for both power and data communications. As known to those skilled in the art, a vehicle's CAN bus is a vehicle bus standard that uses a message-based protocol designed to allow microcontrollers and devices to communicate with each other within a vehicle without a host computer. It is preferred that data communications be performed over wireless communication link 49 via wireless communication system 62 using, for example, Bluetooth or Wi-Fi capability. However, in some instances, it may be useful to communicate the information to and from guidance controller 60 via a single cable interface onto the CAN bus of machine 20 for remote display, setup, and/or control.

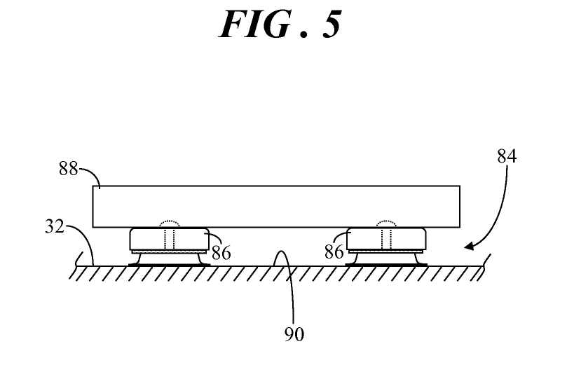

Referring to FIGS. 1 and 5, FIG. 5 shows an exemplary shock mount system 84 for components within integrated machine guidance system 22. It should be recalled that integrated machine guidance system 22 is fixed via mount 24 to critical device 26 of machine 20. In some embodiments, mount 24 may be an anti-vibration shock mount. However, in alternative embodiments, mount 24 may be a rigid mount 24 that does not include anti-vibration or shock dampening capability. When mount 24 is fixed or rigid, or when additional vibration dampening is needed in conjunction with an anti-vibration shock mount 24, integrated machine guidance system 22 may include shock mount system 84 for protecting those components that might otherwise be susceptible to damage or measurement error due to vibration or shock.

In this example, shock mount system 84 includes multiple mechanical shock absorbers 86 coupled to a bottom surface of a circuit board element 88. Circuit board element 88 may be a circuit board upon which certain components are fabricated, or circuit board element 88 may be a box in which the certain components are housed. In either instance, circuit board element 88 is fastened to an inner surface 90 of housing 32 with shock absorbers 86 interposed between circuit board element 88 and inner surface 90 of housing 32. Circuit board element 88 may include, for example, guidance controller 60, receivers 54, 68, and 72 (see FIG. 4), or any other component enclosed in housing 32 that may be susceptible to damage or measurement error due to vibration or shock.

Shock absorbers 86 are configured to absorb or dampen the energy of sudden impulses that may be emanating from critical device 26 and/or machine 20 as they are moved about so as to largely limit or prevent damage or measurement error due to vibration or shock to the components of circuit board element 88. Those skilled in the art will recognize that shock mount system 84 can be formed from a wide variety of mechanical fastener, bushing, and shock absorber designs capable of elastically connecting circuit board element 88 to housing 32 in order to smooth out or dampen a shock impulse.

By now, it should be appreciated that embodiments of the invention entail an integrated machine guidance system for guiding a critical device of a machine. The machine may be earth-moving equipment, such as an excavator, backhoe, bulldozer, loader, motor grader, and the critical device entails the working implement of the machine, such as a blade, drill, bucket, or any other ground-engaging tool for which guidance is provided via the machine guidance and control system. Multiple components such as antennas, receivers, a guidance controller, cameras, and sensor system are built into the machine guidance system to form a standalone unit, i.e., an integrated machine guidance system. Such an integrated approach achieves improvements in portability between multiple machines, ease of installation, and cost savings. Furthermore, there is no requirement for specialized equipment inside the cab of the machine, thereby greatly reducing or eliminating the need for multiple cables penetrating the cab of the machine and the costs associated therewith.

One embodiment of the invention provides a system for guiding a critical device of a machine. The system includes global navigation satellite system (GNSS) antennas and a GNSS receiver connected to the GNSS antennas. A guidance controller is connected to the GNSS receiver. The guidance controller is adapted to compute an actual position of the critical device and determine a direction that the critical device should move to arrive at a desired position. A display unit in communication with the guidance controller provides an indication of the direction that the critical device should move, and a housing encloses the GNSS antennas, the GNSS receiver, and the guidance controller.

The display unit may be coupled to an external surface of the housing and a mounting element is attached to the housing. The mounting element is adapted for attachment to the critical device such that the display unit is visible at the operator station. The system may further include a wireless communication system and a remote display unit that is located physically separate from the housing. The guidance controller is configured to communicate with the remote display unit via the wireless communication system. Both of the display units can provide an indication of the direction that the critical device of the machine should move.

While the principles of the inventive subject matter have been described above in connection with specific embodiments, it is to be clearly understood that the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims. The various functions or processing blocks discussed herein and illustrated in the Figures may be implemented in hardware, firmware, software or any combination thereof. Further, the phraseology or terminology employed herein is for the purpose of description and not of limitation.

The foregoing description of specific embodiments reveals the general nature of the inventive subject matter sufficiently so that others can, by applying current knowledge, readily modify and/or adapt it for various applications without departing from the general concept. Therefore, such adaptations and modifications are within the meaning and range of equivalents of the disclosed embodiments. The inventive subject matter embraces all such alternatives, modifications, equivalents, and variations as fall within the spirit and broad scope of the appended claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

What is claimed is:

1. A system for guiding a critical device of a machine comprising:
global navigation satellite system (GNSS) antennas;
a GNSS receiver connected to said GNSS antennas;
a wireless communication system for wireless communication with a remote source, said wireless communication system being configured to receive at least a georeference file;
a guidance controller connected to each of said GNSS receiver and said wireless communication system, said guidance controller being adapted to compute an actual position of said critical device and determine a direction that said critical device should move to arrive at a desired position in response to said georeference file;
a display unit in communication with said guidance controller for providing an indication of said direction that said critical device should move; and
a housing enclosing said GNSS antennas, said GNSS receiver, said guidance controller, and said wireless communication system.

2. The system of claim 1 wherein said wireless communication system comprises a local area network transceiver.

3. The system of claim 1 wherein said wireless communication system utilizes at least one of a Bluetooth and a Wi-FI communication standard.

4. The system of claim 1 wherein said display unit is located physically separate from said housing and said guidance controller being configured to communicate with said display unit via said wireless communication system.

5. The system of claim 1 wherein said display unit is coupled to an external surface of said housing.

6. The system of claim 5 wherein said display unit includes an arrangement of indicators adapted to indicate said direction that said critical device should move.

7. The system of claim 6 wherein said indicators comprise a plurality of lamps arranged in a grid pattern, and wherein activation of certain ones of said lamps provides said indication of said direction that said critical device should move.

8. The system of claim 1 further comprising a mounting element attached to said housing, said mounting element being adapted for attachment to said critical device.

9. The system of claim 8 wherein said critical device comprises an implement that is spaced apart from a cab of said machine, and said rigid mount is adapted for attachment to said implement.

10. The system of claim 1 further comprising a shock mount interconnected between said guidance computer and said housing.

11. The system of claim 1 further comprising a correction receiver and antenna system enclosed in said housing and coupled to said guidance controller, said correction receiver and antenna system being adapted for providing real-time kinematic corrections.

12. The system of claim 1 further comprising a sensor system enclosed in said housing.

13. The system of claim 1 further comprising at least one camera coupled to said housing and in communication with said guidance controller, said at least one camera being configured to provide an image of an environment proximate said at least one camera to said guidance controller.

14. The system of claim 1 further comprising an input element in communication with said guidance controller and configured to receive a laser level signal from an external laser level sensor, wherein said guidance controller is adapted to guide movement of said critical device in response to said laser level signal received from said laser level sensor.

15. The system of claim 1 further comprising a pass count indicator in communication with said guidance controller and configured to count a quantity of excursions that said machine made over a predetermined terrain area.

16. A system for guiding a critical device of a machine, said machine including an operator station at a first location that is physically spaced apart from a second location of said critical device, and said system comprising:
global navigation satellite system (GNSS) antennas;
a GNSS receiver connected to said GNSS antennas;
a guidance controller connected to said GNSS receiver, said guidance controller being adapted to compute an actual position of said critical device and determine a direction that said critical device should move to arrive at a desired position;
a housing enclosing said GNSS antennas, said GNSS receiver, and said guidance controller;
a display unit coupled to an external surface of said housing, said display unit being in communication with said guidance controller for providing an indication of said direction that said critical device should move; and
a mounting element attached to said housing, said mounting element being adapted for attachment to said critical device such that said display unit is visible at said operator station.

17. The system of claim 16 wherein said mounting element comprises a rigid mount, and said system further comprises a shock mount interconnected between said guidance computer and said housing.

18. The system of claim 1 further comprising a sensor system enclosed in said housing.

19. A system for guiding a critical device of a machine comprising:
global navigation satellite system (GNSS) antennas;
a GNSS receiver connected to said GNSS antennas;
a wireless communication system for wireless communication with a remote source, said wireless communication system being configured to receive at least a georeference file;
a guidance controller connected to each of said GNSS receiver and said wireless communication system, said guidance controller being adapted to compute an actual position of said critical device and determine a direction that said critical device should move to arrive at a desired position in response to said georeference file;
a housing enclosing said GNSS antennas, said GNSS receiver, said guidance controller, and said wireless communication system;
a first display unit coupled to an external surface of said housing and in wired communication with said guidance controller; and
a second display unit that is located physically separate from said housing, said guidance controller being configured to communicate with said second display unit via said wireless communication system, wherein said first and second display units are configured to provide an indication of said direction that said critical device should move.

20. The system of claim 19 wherein:
said machine includes an operator station at a first location that is physically spaced apart from a second location of said critical device;
said second display unit resides at said operator station; and
said system further comprises a mounting element attached to said housing, said mounting element being adapted for attachment to said critical device such that said first display unit is visible at said operator station.
